(19) United States
(12) Patent Application Publication
(10) Pub. No.: US 2012/0092525 A1
(43) Pub. Date: Apr. 19, 2012

(54) IMAGE CAPTURE DEVICE

(75) Inventor: Hiroya KUSAKA, Hyogo (JP)

(73) Assignee: PANASONIC CORPORATION, Osaka (JP)

(21) Appl. No.: 13/269,671

(22) Filed: Oct. 10, 2011

(30) Foreign Application Priority Data
Oct. 13, 2010 (JP) 2010-230209
Sep. 27, 2011 (JP) 2011-211242

(51) Int. Cl. H04N 5/76

(52) U.S. Cl. 348/231.99

(57) ABSTRACT

The image capture device in which if a super resolution processor is not turned ON, a drive controller outputs a read instruction to an imager at a first interval to get a single image. If the super resolution processor is ON, the drive controller outputs the read instructions to the imager at a second interval, which is shorter than the first interval, and the super resolution processor performs super resolution processing on the images obtained, thereby generating image data representing a new image.

### BACKGROUND OF THE INVENTION

1. Field of the Invention

The present invention relates to an image capture device.

2. Description of the Related Art

Recently, camcorders, digital cameras and other image capture devices not only have had their size and weight further reduced but also have their maximum zoom power further increased. For that purpose, in a lot of consumer electronic products currently available, a digital zoom function (which is also called an “electronic zoom function”) is combined with a normal optical zoom function to realize a very high zoom power. For example, Japanese Patent Application Laid-Open Publication No. 1-261086 (which will be referred to herein as “Patent Document No. 1” for convenience sake) discloses an image capture device with a digital zoom function.

In performing digital zoom processing, a conventional image capture device generates image data by selectively using only some of the pixels of its imager according to the zoom power specified. Specifically, the higher the zoom power specified, the smaller the number of pixels actually used in all pixels of the imager. And when displayed, that image data is subjected to interpolation processing (which is so-called “pixel number increase processing”), thereby zooming in on the image. As a result, the higher the zoom power specified, the coarser the image gets and the more significantly its image quality deteriorates. Since there is a growing demand for even better image quality provided by image capture devices, such zoom power increase processing with the digital zoom does have a limit in practice.

It is therefore an object of the present invention to provide an image capture device that allows the user to shoot an image so that its image quality hardly deteriorates even when the digital zoom function is turned ON.

### SUMMARY OF THE INVENTION

An image capture device according to the present invention includes: an optical system configured to produce a subject image; an imager configured to receive the subject image, to generate an image signal and outputs the image signal in accordance with a read instruction; a drive controller configured to control an interval at which the read instruction is output to the imager; a memory configured to store image data that has been obtained based on the image signal; a motion estimating section configured to estimate at least one motion vector with respect to the subject based on the image data of multiple images; and a super resolution processor configured to perform super resolution processing for generating image data representing a new image by synthesizing together the multiple images by reference to the at least one motion vector. If the super resolution processor is not turned ON, the drive controller outputs the read instruction to the imager at a first interval. But if the super resolution processor is turned ON, the drive controller outputs the read instructions to the imager a number of times at a second interval, which is shorter than the first interval, and the memory stores image data representing multiple images that have been obtained in accordance with the read instructions.

The new image generated by the super resolution processor may have a greater number of pixels than any of the multiple images.

The super resolution processor may synthesize the multiple images together by making correction on a positional shift between the multiple images using the at least one motion vector.

The multiple images may include one basic image and at least one reference image. The motion estimating section may estimate the at least one motion vector based on the position of a pattern representing the subject on the basic image and the position of a pattern representing the subject on the at least one reference image. The super resolution processor may make correction on the positional shift between the multiple images based on the magnitude and direction of motion represented by the at least one motion vector so that the respective positions of the pattern representing the subject on the basic image and on the at least one reference image agree with each other.

The super resolution processing may perform super resolution processing for generating image data representing a new image by synthesizing together the multiple images with some pixels of the images shifted from each other.

The image capture device may further include a controller configured to determine whether or not to turn ON the super resolution processor, and configured to control changing the modes of operation from a normal shooting mode into a digital zoom mode, and vice versa. In the normal shooting mode, an image with a first number of pixels may be generated. In the digital zoom mode, digital zoom processing may be carried out using an image with a second number of pixels, which form part of the first number of pixels. The controller may not turn the super resolution processor ON in the normal shooting mode. But when changing the modes of operation from the normal shooting mode into the digital zoom mode, the controller may turn the super resolution processor ON.

The optical system may include at least one lens for carrying out optical zoom processing. In the normal shooting mode, the optical zoom processing may be carried out using the at least one lens. And when the zoom power of the optical zoom processing substantially reaches its upper limit, the controller may change the modes of operation from the normal shooting mode into the digital zoom mode.

In the digital zoom mode, as the zoom power increases, the drive controller may shorten the second interval stepwise and may output the read instructions to the imager a number of times.

The drive controller may determine, by the at least one motion vector, whether or not the magnitude of motion of the subject is greater than a predetermined value, and may shorten the second interval stepwise if the magnitude of motion is greater than the predetermined value.

The drive controller may determine, by the at least one motion vector, whether or not the magnitude of motion of the subject is greater than a predetermined value. If the magnitude of motion is greater than the predetermined value, the controller may not turn the super resolution processor ON. On the other hand, if the magnitude of motion is equal to or smaller than the predetermined value, the controller may turn the super resolution processor ON.

The image capture device may further include an interpolation zoom section configured to increase the number of pixels based on the image data of a single image, and a switcher configured to selectively turn ON one of the super resolution processor and the interpolation zoom section according to a status of the image capture device itself.

The switcher may selectively turn ON one of the super resolution processor and the interpolation zoom section according to a battery charge level of the image capture device itself.

Alternatively, the switcher may selectively turn ON one of the super resolution processor and the interpolation zoom section according to the temperature of the image capture device itself.

According to the present invention, even when the digital zoom function is turned ON, an image can be shot almost without deteriorating its image quality.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating an image capture device 100 as a first specific preferred embodiment of the present invention.

FIG. 2 is a block diagram illustrating an internal configuration for the digital signal processor 7 shown in FIG. 1.

FIG. 3 schematically illustrates an image extracting area 31 on the imager 2 from which an image signal is read out when a digital zoom operation is carried out.

FIG. 4(a) illustrates an image 41 that has been read out from the imager 2 while an image is being shot, while FIG. 4(b) illustrates a digitally zoomed-in image 42.

FIG. 5 is a timing diagram illustrating how to read an image signal from the imager 2.

FIG. 6 is another timing diagram illustrating how an image signal may also be read from the imager 2.

FIG. 7 is a schematic representation illustrating how super resolution processing is carried out by the super resolution processor 13 of the digital signal processor 7 shown in FIG. 1.

FIG. 8 illustrates conceptually how to make a correction on a positional shift between multiple images.

FIG. 9 shows how the image capture device 100 changes the frame rate and the number of images to be synthesized to carry out the super resolution processing according to the zoom power.

FIG. 10 illustrates how image signals are obtained from the imager 2 and what image is generated as a result of the super resolution processing after the digital zoom operation has been started as shown in FIG. 9 (i.e., after the digital zoom mode has been turned ON).

FIG. 11 is a flowchart showing an operation algorithm to be carried out in the digital zoom mode according to the first preferred embodiment of the present invention.

FIG. 12 schematically illustrates a motion estimation area of the motion estimating section 12 shown in FIG. 2.

FIG. 13 illustrates a timing diagram showing how image signals are obtained from the imager 2 shown in FIG. 1 and what image is generated as a result of the super resolution processing.

FIG. 14 is a flowchart showing an operation algorithm to be carried out in the digital zoom mode according to the second preferred embodiment of the present invention.

FIG. 15 illustrates a configuration for an image capture device 101 as a third preferred embodiment of the present invention.

FIG. 16 illustrates a detailed configuration for the digital signal processor 17, the switcher 22 and their associated circuit sections of the image capture device 101 of the third preferred embodiment.

FIG. 17 illustrates a timing diagram showing how image signals are obtained from the imager 2 shown in FIG. 1.

FIG. 18 is a flowchart showing an operation algorithm to be carried out in the digital zoom mode according to the third preferred embodiment.

FIG. 19 illustrates a modified example of a preferred embodiment of the present invention.

FIG. 20 illustrates an example in which an image signal is retrieved from a shifted position.

FIG. 21 illustrates another modified example of a preferred embodiment of the present invention.

### DETAILED DESCRIPTION OF PREFERRED EMBODIMENTS

Hereinafter, preferred embodiments of an image capture device according to the present invention will be described with reference to the accompanying drawings. An image capture device as a preferred embodiment of the present invention has only to have the ability to shoot moving pictures and/or still pictures. Examples of such image capture devices include digital still cameras with only the ability to shoot still pictures, digital camcorders with only the ability to shoot moving pictures, and digital still cameras, digital camcorders and other mobile electronic devices that have the ability to shoot both still pictures and moving pictures alike.

In the following description, “video” will be used as a generic term that means both a moving picture and a still picture.

### Embodiment 1

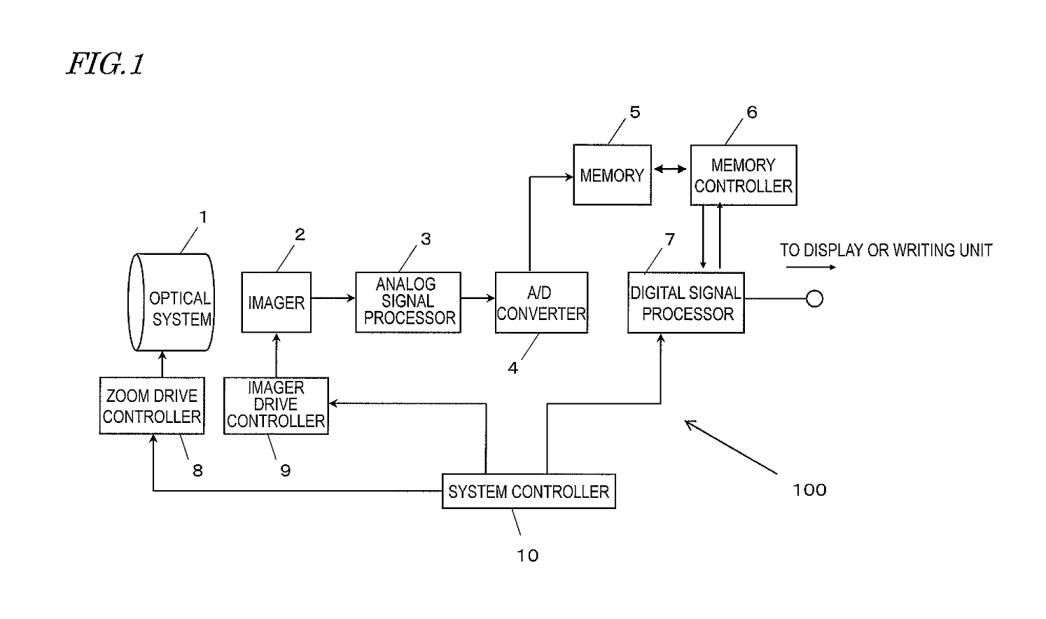

FIG. 1 is a block diagram illustrating an image capture device 100 as a first specific preferred embodiment of the present invention. The image capture device 100 includes an optical system 1, an imager 2, an analog signal processor 3, an A/D converter 4, a memory 5, a memory controller 6, a digital signal processor 7, a zoom drive controller 8, an imager drive controller 9 and a system controller 10.

The optical system 1 includes multiple groups of lenses. By using those groups of lenses, an optical zoom function is realized. As for the optical zoom function of the optical system 1, its zoom power is supposed herein to vary continuously from 1× through Ro× (where Ro>1). In this first preferred embodiment, Ro is supposed to be 10 as an example.

The imager 2 is a photoelectric transducer, which is known as a CCD sensor or a MOS sensor. The imager 2 converts the light received into an electrical signal, of which the signal value represents the intensity of that incoming light. For example, in response to a single read instruction, the imager 2 outputs an electrical signal (which is an analog video signal) representing pixels that form a single image.

The analog signal processor 3 is a signal processor that subjects the analog video signal to various kinds of signal processing including gain adjustment and noise reduction. The analog signal processor 3 outputs a video signal thus processed (as an analog video signal).

The A/D converter 4 converts the analog signal into a digital signal. For example, the A/D converter 4 receives the analog video signal and changes its signal value into discrete ones with respect to multiple preset threshold values, thereby generating a digital signal.

The memory 5 is a storage device that stores the digital data and may be a DRAM, for example.

The memory controller 6 controls reading and writing data from/on the memory 5.

The digital signal processor 7 subjects the input digital signal to various kinds of digital signal processing and outputs a processed digital signal. In this case, examples of those various kinds of digital signal processing include separating the digital signal into a luminance signal and a color difference signal, noise reduction, gamma correction, sharpness enhancement processing, digital zoom, and other kinds of digital processing to be carried out on a camera. In performing the digital zoom processing, the image quality of the digitally zoomed video can be improved by performing super resolution processing as will be described later.

The zoom drive controller 8 controls driving some of the groups of lenses in the optical system 1 and changes the zoom power of the optical system 1 into any arbitrary value.

The imager drive controller 9 drives the imager 2 and controls not only reading the signal itself but also the number of pixels, the number of lines, the charge storage time (exposure time) and the read cycle time when the signal is read.

The system controller 10 performs an overall control on the zoom drive controller 8, the imager drive controller 9 and the digital signal processor 7 and instructs them to operate appropriately in cooperation with each other when video is going to be shot. For example, the system controller 10 may be implemented as a microcomputer that executes a computer program that has been loaded into a RAM such as a DRAM, or an SRAM, for example. Alternatively, the system controller 10 may also be implemented as a combination of a microcomputer and a control program stored in its associated memory just like an ASIC (Application Specific IC). Still alternatively, the system controller 10 may also be implemented as a DSP (Digital Signal Processor) as well.

Hereinafter, it will be described briefly how the image capture device 100 of this preferred embodiment operates. The optical system 1 receives light that has come from the subject and produces a subject image on the imager 2. In this case, the zoom power is controlled by the zoom drive controller 8. When the subject image is produced on the imager 2, the imager 2 outputs an electrical signal representing the subject image (as an analog video signal). In response, the analog signal processor 3 subjects the analog video signal supplied from the imager 2 to predetermined signal processing and outputs a processed analog video signal. Then, the A/D converter 4 receives the analog video signal from the analog signal processor 3, converts the analog video signal into a digital one and then outputs the digital video signal. The memory 5, which functions as a buffer memory, temporarily stores that digital video signal.

The digital signal processor 7 makes the memory controller 6 read the digital video signal from the memory 5, subjects the digital video signal to various kinds of digital signal processing, and then stores video data back into the memory 5 if necessary.

The image capture device 100 of this preferred embodiment is partly characterized by the processing performed by the digital signal processor 7. Thus, the configuration and operation of the digital signal processor 7 will be described in detail.

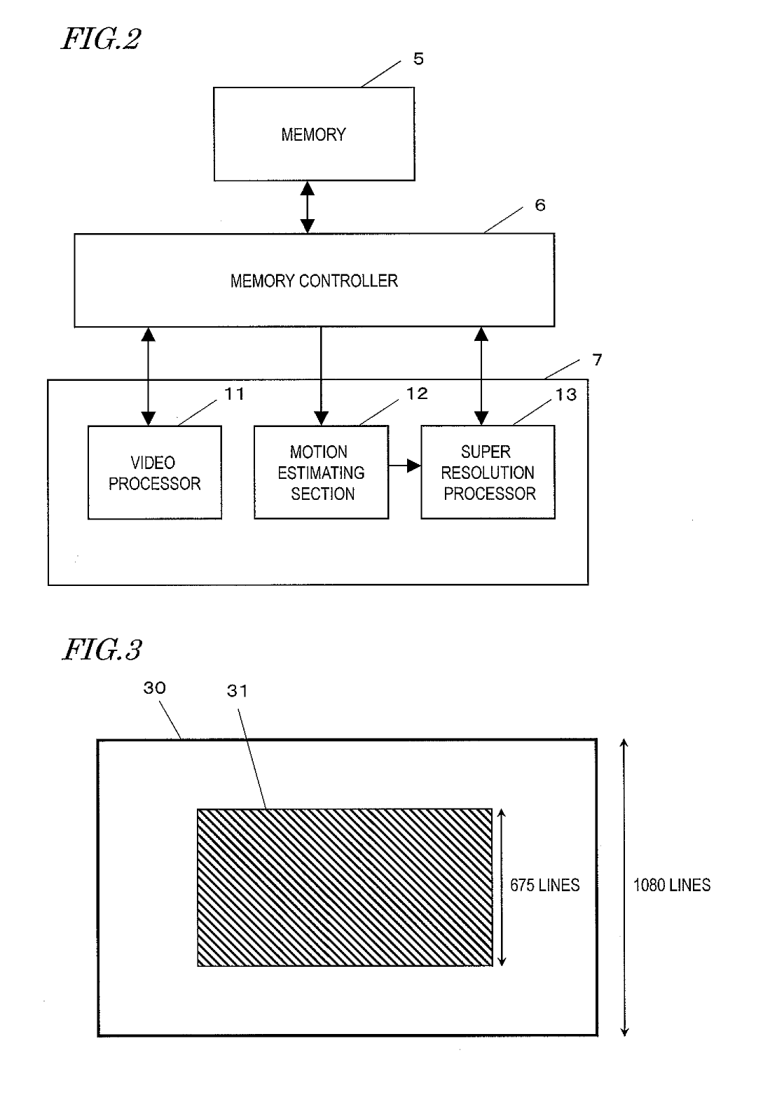

FIG. 2 is a block diagram illustrating an internal configuration for the digital signal processor 7 shown in FIG. 1. The video processor 11 shown in FIG. 2 performs various kinds of digital processing to be done for a camera, including separating a video signal into a luminance signal and a color difference signal, noise reduction, gamma correction, and sharpness enhancement processing. The video processor 11 reads the video signal yet to be processed from the memory 5, and writes the processed video signal on the memory 5, by way of the memory controller 6. The motion estimating section 12 and super resolution processor 13 shown in FIG. 2 perform the high-quality digital zoom processing mentioned above as will be described in detail later.

FIG. 3 schematically illustrates an image extracting area 31 on the imager 2 from which an image signal is read out when a digital zoom operation is carried out. In the digital zoom mode, the digital zoom processing is carried out on the entire image capturing area 30 of the imager 2 (i.e., the largest possible area on which an image can be captured) as shown in FIG. 3. In accordance with an instruction given by the imager drive controller 9, the imager 2 extracts an image signal representing a subject image, which has been produced on that part 31 of the image capturing area 30. As will be described later, the image signal thus extracted will be subjected to image expansion processing (i.e., pixel number increase processing) by the digital signal processor 7.

The number of horizontal scan lines for scanning an image to be read from the imager 2 should be approximately 1080 per frame according to the 60 P High-Definition standard. Thus, in the following description of preferred embodiments, the number of horizontal scan lines for scanning an image to be read from the imager 2 when a shooting session is carried out in a normal mode, not in the digital zoom mode, is supposed to be 1080. In the example illustrated in FIG. 3, the number of horizontal scan lines for scanning an image to be read from the imager 2 in the digital zoom mode is supposed to be 648. In that case, the digital zoom power Re becomes 1.6. According to this first preferred embodiment, the maximum value of Re is supposed to be three.

Also, in accordance with the instruction given by a user (not shown) of this image capture device 100, when the image capture device 100 performs a zoom operation, the optical zoom is supposed to be carried out first by the optical system 1. And when the zoom power of the optical zoom almost reaches its upper limit, the modes of zoom operation are changed into digital zoom to further zoom in on the subject. In that case, the maximum zoom power of the image capture device 100 becomes equal to the product of Ro and Re in total.

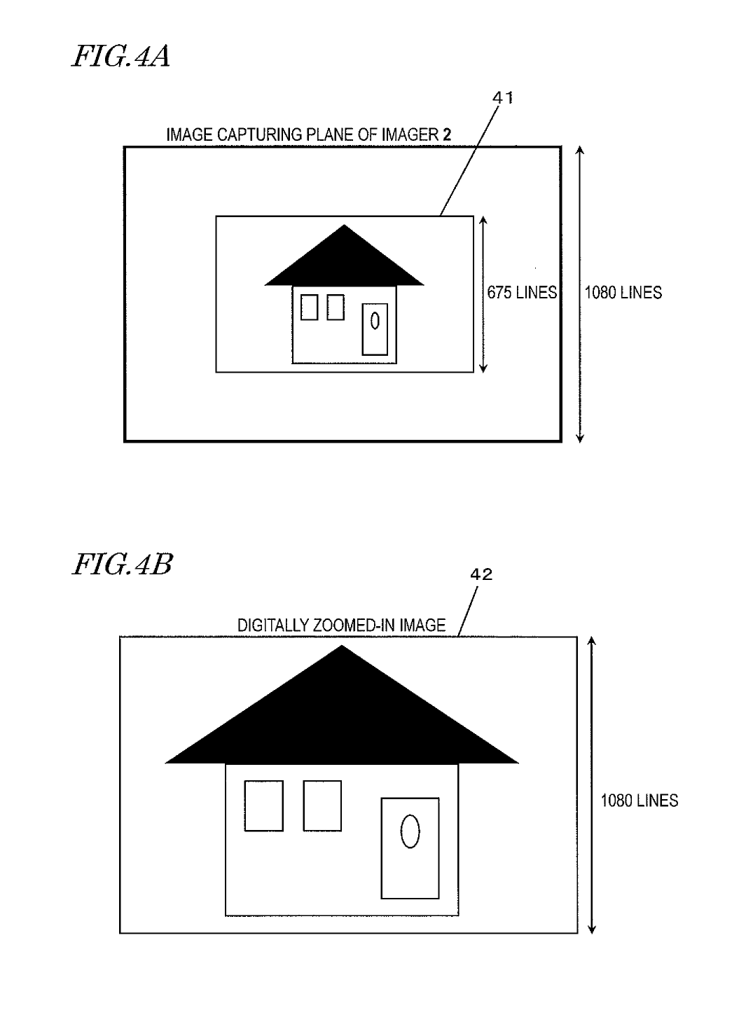

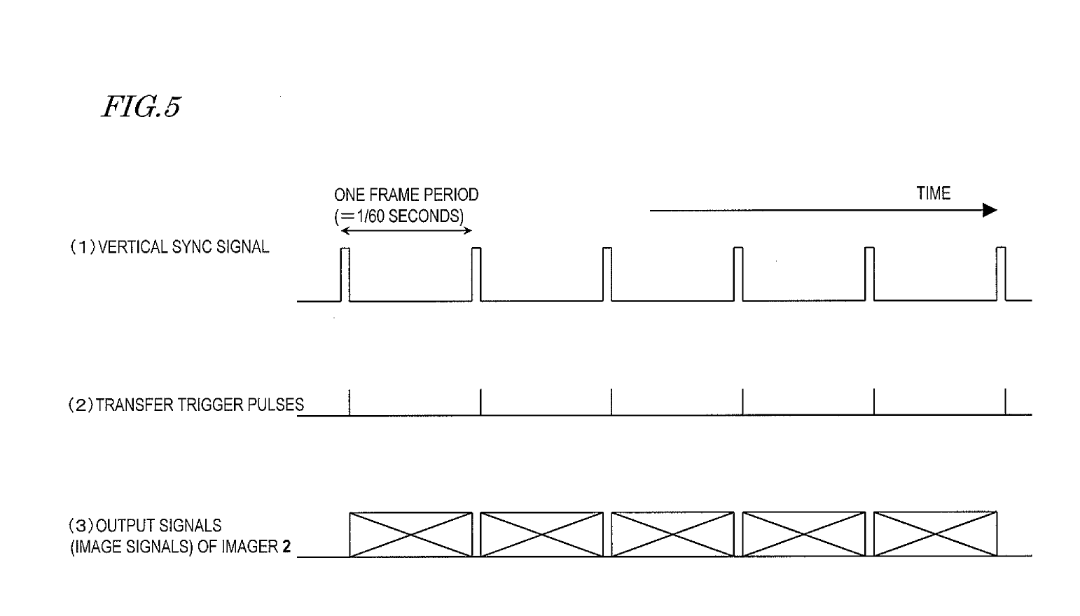

FIG. 4(a) illustrates an image 41 that has been read out from the imager 2 while an image is being shot, while FIG. 4(b) illustrates a digitally zoomed-in image 42. By zooming in on a part of the image represented by the light that has been received by the imager 2, the image shot can be enlarged as in the optical zoom operation. According to the conventional digital zoom processing, the higher the digital zoom power, the coarser the image gets and the more significantly the image quality deteriorates. However, according to this preferred embodiment, the digital zoom processing can be carried out so as not to deteriorate the image quality by performing the super resolution processing as will be described later.

FIG. 5 is a timing diagram illustrating how to read an image signal from the imager 2. Portion (1) of FIG. 5 shows vertical sync pulses for a TV signal, portion (2) of FIG. 5 shows transfer trigger pulses, which trigger transferring electric charges that have been stored in the imager 2 to an external device, and portion (3) of FIG. 5 shows the output signal (image signal) of the imager 2. As shown in FIG. 5, in the image capture device 100 of this preferred embodiment, the image signal stored in the imager 2 can be read periodically and continuously. The image signal is read in response to a reading trigger pulse that has been applied by the imager drive controller 9 to the imager 2 in accordance with the instruction given by the system controller 10. If the image capture device 100 of this preferred embodiment is going to shoot a moving picture compliant with the standard TV scanning method, then a vertical sync pulse will be applied once a frame in accordance with the TV scanning method. Or if the TV scanning method is interlaced scanning, then a vertical sync pulse will be applied once a field. On the other hand, if the image capture device 100 is going to shoot a still picture as in a digital still camera, then a vertical sync pulse will be applied every time the through-the-lens image displayed for monitoring purposes (which is displayed on the viewfinder or the LCD monitor of a digital still camera) is refreshed. Naturally, when a still picture is going to be shot, the periodic operation shown in FIG. 5 does not always have to be performed, if not necessary, so that the image can be read out at an arbitrary timing in response to the shooter's shutter release operation. According to this first preferred embodiment, one period (i.e., the frame rate) of the vertical sync signal when a moving picture is going to be shot without performing the digital zoom is supposed to be 60 frames per second (fps). However, this is just an example of the present invention and is in no way limiting.

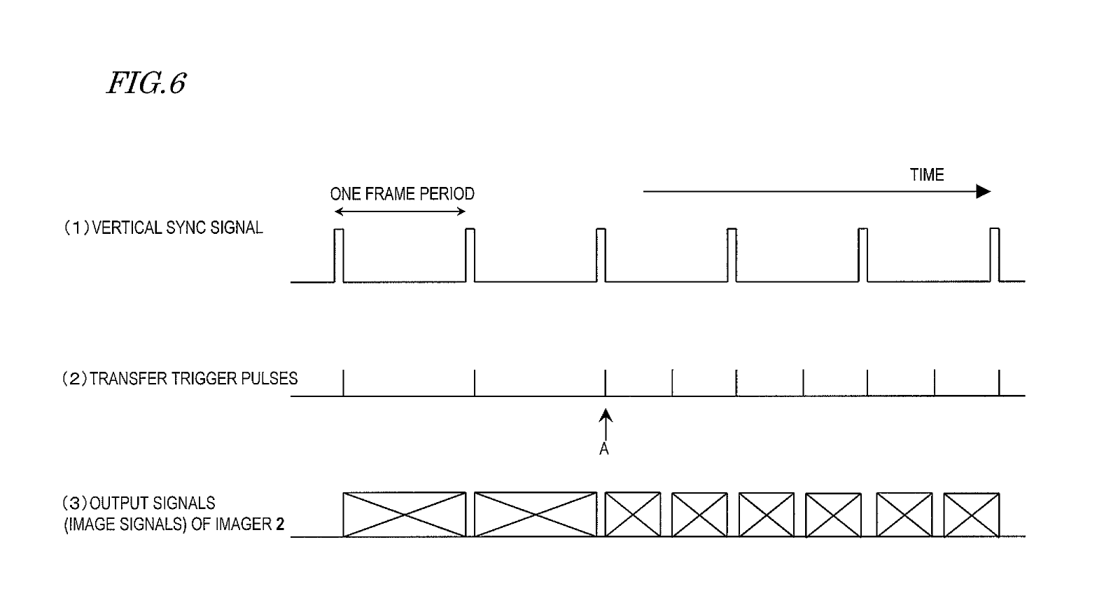

FIG. 6 is another timing diagram illustrating how an image signal may also be read from the imager 2. In the example illustrated in FIG. 6, to read more than one image signal (e.g., two image signals) per frame, the imager drive controller 9 changes the frequency at which the transfer trigger pulses are applied from a point in time A on. In this manner, the image capture device 100 of this preferred embodiment can change the image signal reading period arbitrary by changing the frequency at which the transfer trigger pulses are applied by the imager drive controller 9.

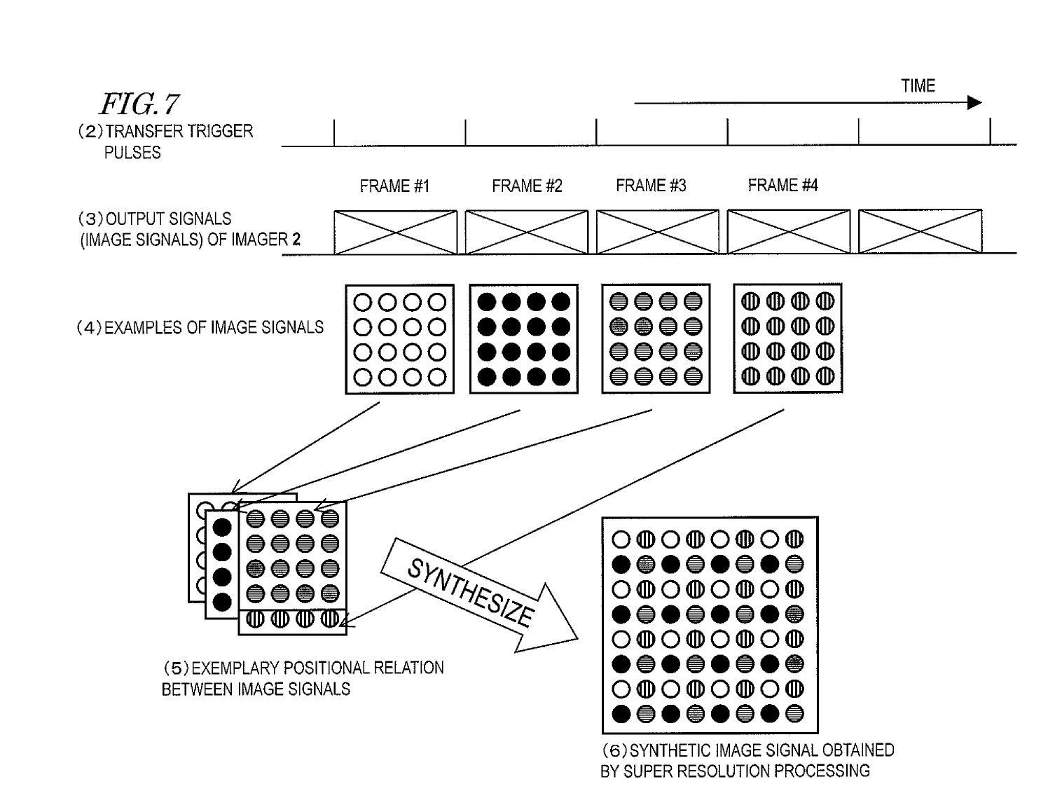

FIG. 7 is a schematic representation illustrating how super resolution processing is carried out by the super resolution processor 13 of the digital signal processor 7 shown in FIG. 1. In FIG. 7, portions (2) and (3) show the transfer trigger pulses that have already been described with reference to FIG. 5 and the output signals (image signals) of the imager 2, respectively.

Portion (4) of FIG. 7 shows examples of image signals that have been supplied from the imager 2 at respective timings associated with Frames #1 through #4. In this case, the dots illustrated as open circles, solid circles and so on represent signal components corresponding to respective pixels of an image. Portion (5) of FIG. 7 shows the relation in spatial position between the four image signals that have been read.

Generally speaking, when images are shot with an image capture device held with hands, those image shots will not be aligned with each other (i.e., have a spatial shift between them) due to a camera shake caused by the shooter's hand or body tremors. That is why even if the same subject is shot, the spatial location of the subject will often be different from one image to another.

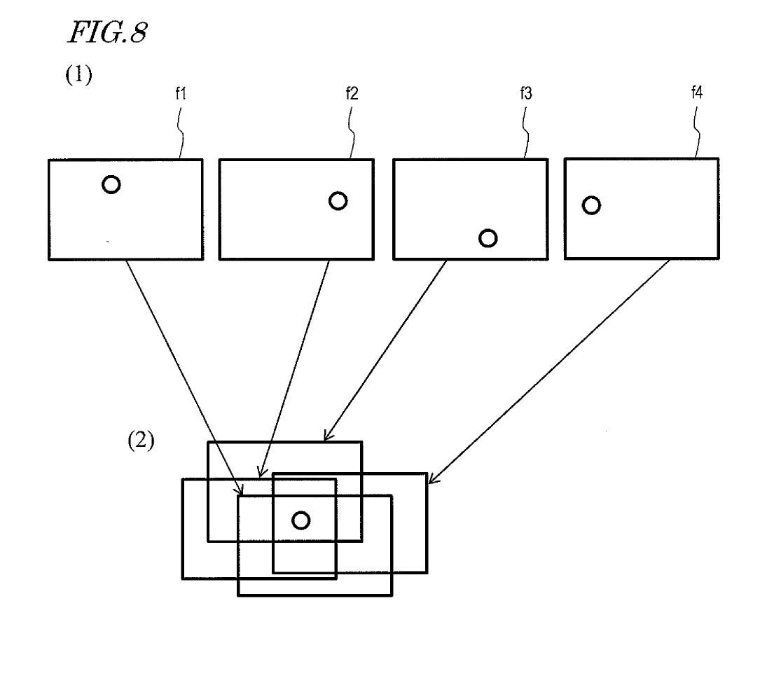

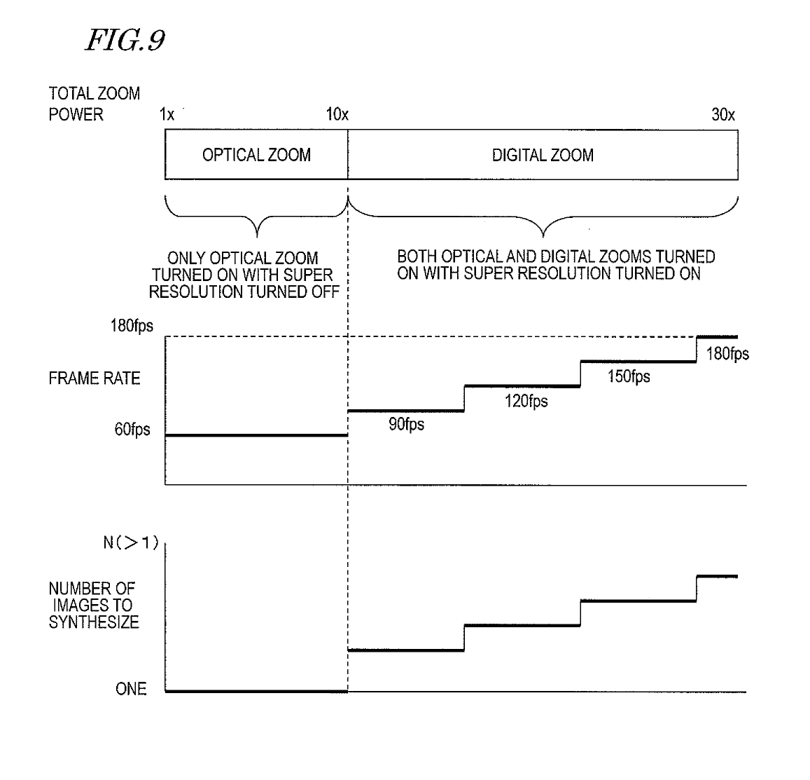

This point can be understood more easily by reference to FIG. 8. Specifically, portion (1) of FIG. 8 illustrates four frames f1 through f4 that have been obtained by shooting the same subject, which is indicated by the open circle ◯, while portion (2) of FIG. 8 illustrates a relation in position between the images that have been laid one upon the other with respect to that subject.

As can be seen from portion (1) of FIG. 8, even though the same subject has been shot sequentially, the subject is located at mutually different positions in the frames due to the camera shake.

According to this preferred embodiment, the resolution of an image is increased by using a number of frames that include the same subject. In all of the four frames f1 through f4, the same subject ◯ is included. That is why if a new piece of image information is generated by laying one upon the other those frames including the same subject so that the same pieces of information represented by their overlapping portions are combined together as shown in portion (2) of FIG. 8, the resolution of the image can be increased according to the number of those frames synthesized together. It should be noted that there is no need to designate a specific subject in the images. Instead, most closely resembling patterns need to be found in those images. For example, a pattern in a small area may be used as a reference or a person's face in the image may be used as a pattern.

Let's go back to FIG. 7 now.

Portion (5) of FIG. 7 illustrates a relation in position between the four images that have been laid one upon the other with respect to a subject that is included in all of those four images. This drawing corresponds to portion (2) of FIG. 8.

And portion (6) of FIG. 7 illustrates a synthetic image obtained by synthesizing together the four images shown in portion (5) of FIG. 7 through the super resolution processing.

The image capture device 100 of this preferred embodiment synthesizes together multiple images that have been shot by the imager 2 according to the magnitude of their spatial positional shift, thereby generating a pixel shifted image.

More specifically, an image that has been shot for the first time is used as a basic image, in which a rectangular window area A of a predetermined size is set. And images that have been shot after that (which will be referred to herein as “reference images”) are searched for a pattern that is similar to the one included in the window area A. The search range may be defined appropriately. For example, in a reference image, a predetermined range B may be set around a point that has the same sets of coordinates as its associated point in the window area A of the basic image. And that predetermined range B is searched for a similar pattern to the one included in the window area A. In this case, the degree of similarity between the patterns can be estimated by calculating a sum of squared differences (SSD) or a sum of absolute differences (SAD), for example. For instance, a pattern that produces the smallest SSD or SAD may be regarded as a pattern that is similar to the one included in the window area A. And a difference in position between the pattern included in the window area A and its associated similar pattern that has been found in each reference image becomes the magnitude of positional shift. It should be noted that the magnitude of positional shift along with the direction of the shift from the basic image will also be referred to herein as a “motion vector”.

It should be noted that the number of reference images may be defined arbitrarily. For example, the processing described above may be carried out using only one of the images shot.

The image capture device 100 of this preferred embodiment synthesizes the respective images according to the magnitude of that positional shift, thereby producing an image of higher image quality as shown in portion (6) of FIG. 7. This processing will also be referred to herein as “super resolution processing”. As can be seen from FIG. 7, the super resolution image obtained as a result of the super resolution processing as shown in portion (6) of FIG. 7 has a greater number of pixels per unit space (i.e., a higher resolution) than any of the images yet to be synthesized as shown in portion (5) of FIG. 7.

It should be noted that the super resolution processing to be carried out according to the present invention is not the mere pixel number increase processing. Rather, according to this super resolution processing, an image with suppressed disruptive parts can be obtained because the image data of an existent subject is used, and the sharpness of the image is less subject to decrease.

Hereinafter, it will be described what is a difference between the super resolution processing of the present invention and the conventional interpolation method. Suppose a situation where n pixels need to be newly inserted between two adjacent pixels. In that case, according to a conventional interpolation method, the pixel values of the new pixels may be determined based on the pixel values of the two adjacent pixels. For example, if the two adjacent pixels have pixel values a and b, the pixel values of n pixels may be determined so as to change continuously from a through b on a (b−a)/n basis. According to that method, even though the number of pixels increases, the pixel values of the pixels inserted are always determined uniformly by a predetermined method. With such a method adopted, however, the image could collapse or have a decreased degree of sharpness. For example, in the latter case, even if the two adjacent pixels have significantly different luminances (e.g., are located at a profile portion), their interpolated pixels will be generated so as to have gradually changing grayscales at the profile portion. Then the degree of sharpness of an edge will decrease.

The super resolution processor 13 determines whether or not to perform the super resolution processing by seeing if the super resolution processing mode is ON or OFF.

Specifically, if the super resolution processing mode is ON, the super resolution processor 13 performs the super resolution processing. But if the super resolution processing mode is OFF, the super resolution processor 13 does not perform the super resolution processing. When the super resolution processing is performed, the magnitude of positional shift between multiple images is estimated by the motion estimating section 12 (see FIG. 2) and the images are synthesized together based on the magnitude of the spatial shift detected.

The motion estimating section 12 estimates the magnitude and direction of positional shift, that is, a motion vector, between the subject's locations on two or more images (shown in portion (5) of FIG. 7 and) represented by the image signals that have been supplied from the imager 2. To estimate the motion vector, the motion estimating section 12 may adopt so-called block matching between the images for recognizing a pattern using the window area as described above. Alternatively, the motion estimating section 12 may also adopt a phase-only correlation method that uses a Fourier transform, for example. According to this first preferred embodiment, any of those methods may be adopted. Also, the motion estimating section 12 does not have to perform its processing by any particular method, either.

Although, in the above description, the motion estimating section 12 estimates motion vector, that is, the magnitude and direction of the positional shift with respect to the reference image, it is an example. In the case where the direction of the positional shift with respect to the reference image is predefined due to the image-capturing environment, the motion estimating section 12 may not need to estimate the direction, but may estimate only the magnitude of the positional shift. Even if the motion estimating section 12 estimates only the magnitude of the positional shift, it is described in this specification that the motion estimating section 12 estimates the motion vector.

It should be noted that the number of images to be synthesized together to carry out the super resolution processing does not have to be four.

According to this preferred embodiment, the super resolution processing mode is turned ON and OFF by seeing if the digital zoom is ON or OFF.

FIG. 9 shows how the image capture device 100 changes the frame rate and the number of images to be synthesized to carry out the super resolution processing according to the zoom power.

According to this first preferred embodiment, if the image capture device 100 needs to perform a zoom operation in accordance with the instruction given by the user (not shown) of this image capture device 100, the device 100 performs an optical zoom operation first by driving the optical system 1 until its maximum zoom power is almost reached. In this case, the frame rate used by the image capture device 100 is supposed to be a standard one of 60 fps and the super resolution processing mode is supposed to be OFF. Since the super resolution processor does not perform the super resolution processing in this case, the number of images to be synthesized is one.

Next, in accordance with the instruction given by the user (not shown) of this image capture device 100, when the maximum zoom power of the optical zoom operation (e.g., 10× in this example) is almost reached, the digital zoom processing is started. And unless the user instructs otherwise, the zoom power will be increased continuously until the maximum zoom power of the digital still is reached.

Once the digital zoom has been turned ON, as the digital zoom power is increased, the image capture device 100 increases the shooting frame rate stepwise. Specifically, in the example illustrated in FIG. 9, the initial frame rate of 60 fps is increased stepwise to 90 fps, 120 fps, 150 fps and then 180 fps. This processing can be done by making the imager drive controller 9 change the timings to apply the transfer trigger pulses. As a result, the number of images that can be captured within a predetermined amount of time increases. At the same time, the super resolution processing mode is turned ON and the super resolution processor 13 starts performing the super resolution processing.

By performing the super resolution processing on multiple images, the super resolution processor 13 generates a synthetic image of higher image quality. The super resolution processing is carried out by synthesizing together a number of images, each of which has been captured in 1/60 seconds that is one frame period in the normal shooting mode that uses a frame rate of 60 fps. That is to say, as the digital zoom power rises, the number of images to be synthesized together by the super resolution processing increases stepwise.

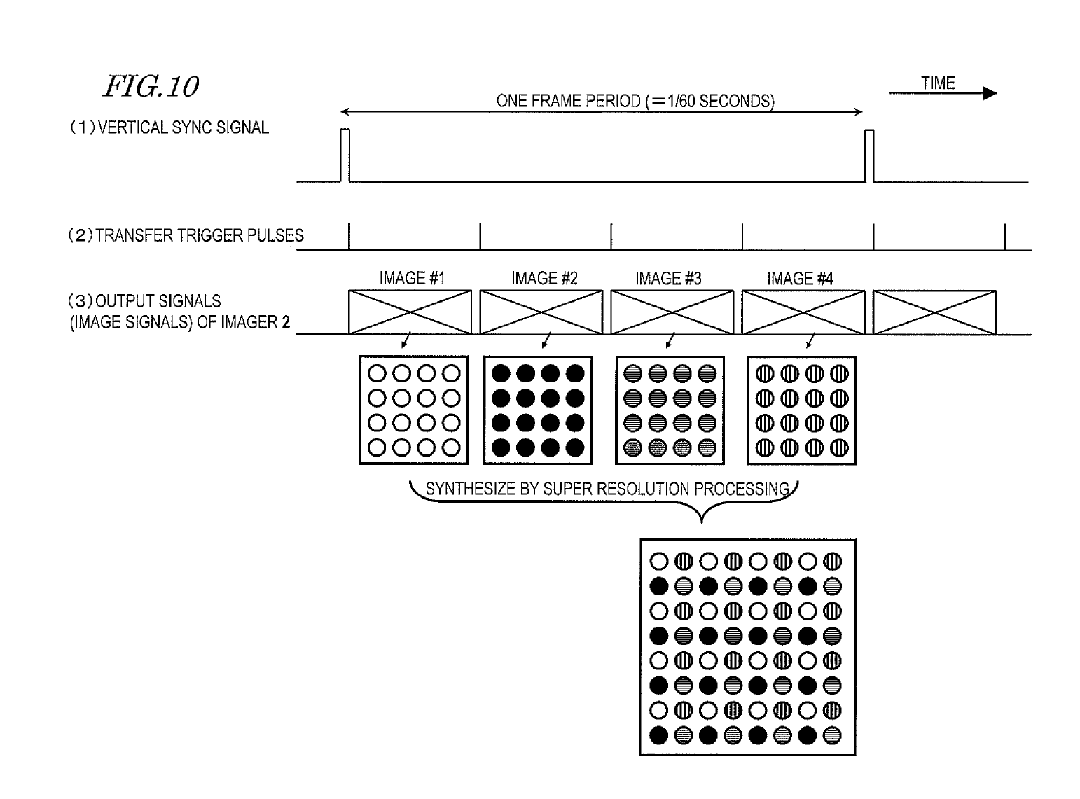

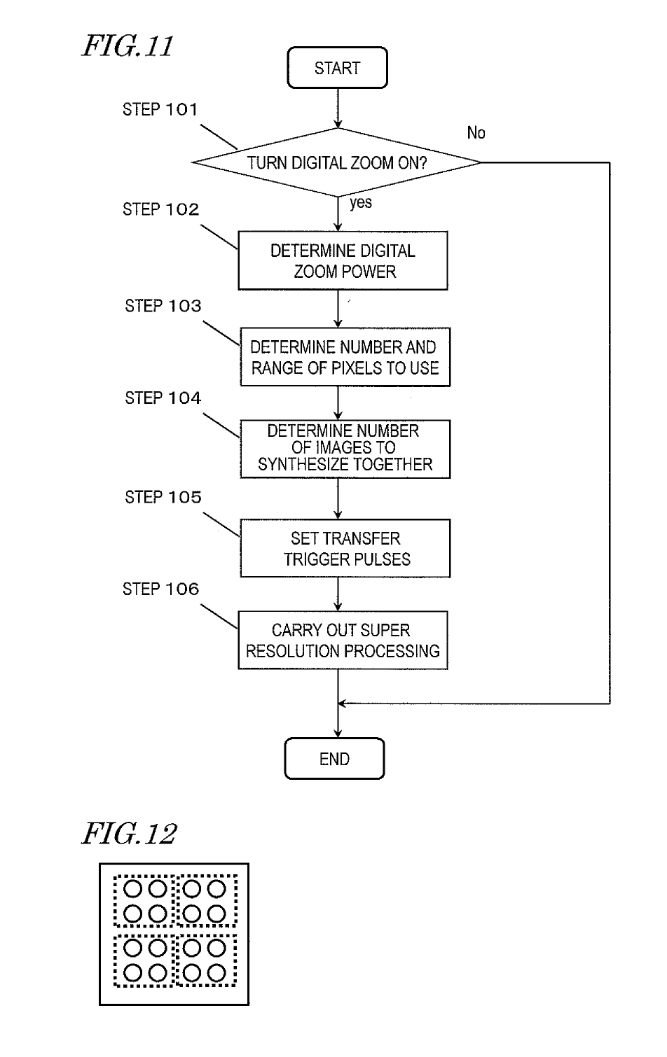

FIG. 10 illustrates how image signals are obtained from the imager 2 and what image is generated as a result of the super resolution processing after the digital zoom operation has been started as shown in FIG. 9 (i.e., after the digital zoom mode has been turned ON). In FIG. 10, portions (1) and (2) illustrate the same vertical sync pulses and transfer trigger pulses as the one shown in FIG. 5. In the example illustrated in FIG. 10, four transfer trigger pulses are applied to the imager 2 during one frame period, thereby getting image signals representing four images.

As shown in FIG. 10, if the zoom power is specified by the user (not shown) of this image capture device 100 when the digital zoom is turned ON, then the imager drive controller 9 increases the frequency at which the transfer trigger pulses are applied, thereby outputting multiple image signals within a period that is normally as long as one frame period. Then, the motion estimating section 12 estimates the magnitude of positional shift between the multiple images obtained, and then notifies the super resolution processor 13 of the result of estimation (i.e., the magnitude of positional shift estimated). In response, based on that magnitude of shift, the super resolution processor 13 performs the pixel shifted synthesis processing, thereby generating a super resolution image of higher image quality.

FIG. 11 is a flowchart showing an operation algorithm to be carried out in the digital zoom mode according to this preferred embodiment. The operation algorithm shown in FIG. 11 is supposed to be either performed by some hardware components built in the system controller 10 or installed as a program in the system controller 10.

Hereinafter, it will be described with reference to FIG. 11 how the image capture device 100 with such a configuration operates according to this preferred embodiment. First off, the zoom power of the image capture device 100 is supposed to be 1×, which is an initial setting, and the user (not shown) of this image capture device 100 is supposed to have instructed starting a zoom operation.

First, in Step 101, the system controller 10 determines whether or not to turn the digital zoom ON by seeing if the zoom power specified by the user is above the upper limit of the optical zoom power.

According to this preferred embodiment, the user's instruction to start a zoom operation is supposed to be entered by sensing a zoom button (not shown) pressed and his or her specified zoom power is supposed to be determined by detecting how long the zoom button is pressed continuously. If the zoom power specified by the user is 10× or less, then the zoom drive controller 8 sets the zoom power of the optical system 1 to be the specified zoom power by controlling some lenses in the optical system 1. As a result, an image can be shot with the zoom power specified. In this case, the digital zoom mode is OFF, so is the super resolution processing mode.

On the other hand, if the zoom power specified by the user is more than 10× that is the upper limit of the optical zoom power, then the system controller 10 turns the digital zoom mode and the super resolution processing mode both ON. Then, the process advances to Step 102.

In Step 102, the system controller 10 determines a specific digital zoom power. More specifically, the system controller 10 determines the digital zoom power by detecting how long the zoom button is pressed continuously by the user. In this case, the digital zoom mode and the super resolution processing mode are both ON. Then, the system controller 10 notifies the digital signal processor 7 of the zoom power determined.

Next, in Step 103, the imager drive controller 9 calculates and determines, based on the digital zoom power that has been determined in the previous processing step 102, the number and the range of pixels to use in the imager 2. In the digital zoom mode, an image portion covering only a part of the pixels that can be used in the imager 2 needs to be read and subjected to the zoom-in processing (pixel number increase processing) to obtain a zoomed-in image. For that reason, the number of pixels to use in the imager 2 needs to be calculated based on the digital zoom power. For example, if the digital zoom power Re is 2×, the imager drive controller 9 determines that an image signal of approximately a quarter of the pixels of the imager 2 be read. In the same way, the imager drive controller 9 determines that an image signal of the pixels contained in the part 31, which includes the central part of the image capturing area 30 as shown in FIG. 3, be read.

It should be noted that the image that has been read from the imager 2 should be subjected to filtering in order to reduce noise and other kinds of processing. That is why to allow some margin for those kinds of processing, actually it is preferred that more than a quarter of the pixels be used in the imager. Also, according to the structure of the imager, the numbers of horizontal and vertical pixels to be scanned directly may be specified. Or as in the case of a CCD, only the number of vertical pixels (or vertical lines) can be specified, and horizontal pixels need to be stored in a memory once and then only a required number of pixels should be retrieved (or cropped). According to this first preferred embodiment, the imager may have either of these two structures. Added to that, if the number of pixels to use in the imager 2 is set to be smaller than the total number of the pixels in the digital zoom mode, that will work favorably in terms of power dissipation and hardware size of the device even when the number of images to be read from the imager 2 (i.e., the frame rate) should be increased in the digital zoom mode.

Next, in Step 104, the number of images to synthesize together in the super resolution processing is determined based on the digital zoom power specified as already described with reference to FIG. 9. As for how to determine the number of images to synthesize together based on the digital zoom power, a table may be drawn up to indicate how much degree of deterioration in image quality caused by digital zoom can be compensated for by synthesizing how many images together through the super resolution processing. And by reference to that table, the number of images to synthesize together may be determined with the digital zoom power specified.

Subsequently, in Step 105, to get the number of images to synthesize together, which has been determined in the previous processing step 104, from the imager 2, the system controller 10 gives an instruction to the imager drive controller 9 and have the imager drive controller 9 apply trigger pulses to the imager 2. As a result, image signals representing the required number of images can be obtained from the imager 2, and are subjected to the signal processing described above.

Finally, in Step 106, the super resolution processor 13 performs the super resolution processing that has already been described with reference to FIGS. 2, 7 and 10 on the digital video signal that has been subjected to the signal processing, thereby obtaining a digitally zoomed-in image of higher image quality.

By performing these processing steps 101 through 106, the image capture device 100 of this preferred embodiment can obtain an image of quality even when the digital zoom mode is ON.

### Embodiment 2

An image capture device as a second specific preferred embodiment of the present invention has substantially the same configuration as its counterpart 100 of the first preferred embodiment shown in FIG. 1. Thus, the second preferred embodiment of the present invention will also be described with respect to the image capture device 100 shown in FIG. 1. In the following description, any component also included in the image capture device 100 shown in FIG. 1 and having substantially the same function as its counterpart is identified by the same reference numeral and a detailed description thereof will be omitted herein.

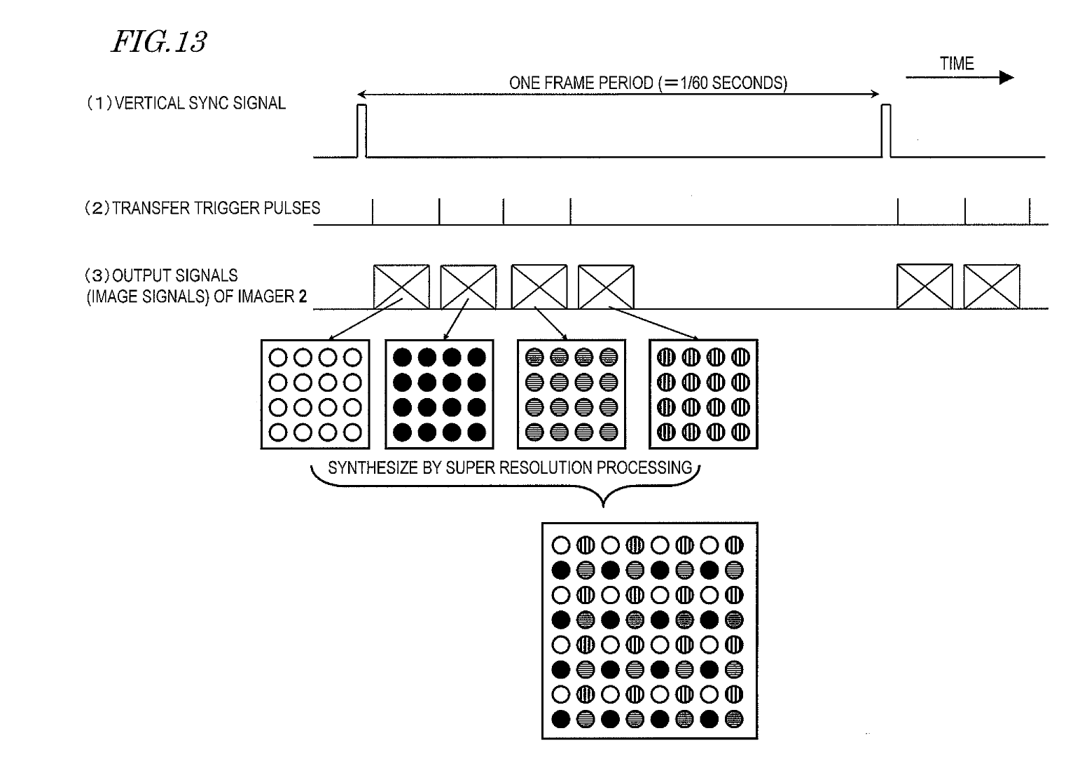

Hereinafter, an image capture device as a second preferred embodiment of the present invention will be described with reference to FIGS. 12, 13 and 14. The image capture device of this preferred embodiment estimates the motion of a target subject between the images shot and adjusts the exposure time according to the magnitude and direction of that motion, which is a major difference from the image capture device of the first preferred embodiment described above. FIG. 12 schematically illustrates a motion estimation area of the motion estimating section 12 shown in FIG. 2. In FIG. 12, the open circles ◯ indicate the arrangement of pixels and dotted squares indicate the four areas where the motion needs to be estimated on the image. In this example, the number of areas is supposed to be four. But this is just an example of the present invention.

FIG. 13 illustrates a timing diagram showing how image signals are obtained from the imager 2 shown in FIG. 1 and what image is generated as a result of the super resolution processing. In FIG. 13, portion (1) illustrates vertical sync pulses, portion (2) illustrates transfer trigger pulses, which are given as a trigger for transferring the electric charges stored in the imager 2 to an external device, and portion (3) illustrates the output signals (image signals) of the imager 2. As shown in FIG. 13, the image capture device of this preferred embodiment sets the intervals at which the transfer trigger pulses are applied to be shorter than in the first preferred embodiment described above based on a result of a subject's motion estimation as will be described later, thereby getting multiple image signals with the exposure time shortened. It should be noted that the signal charges stored in the imager 2 in the interval after the last image signal has been read in one frame period and before the next vertical scanning period begins are drained to the ground in response to a charge drain pulse (not shown).

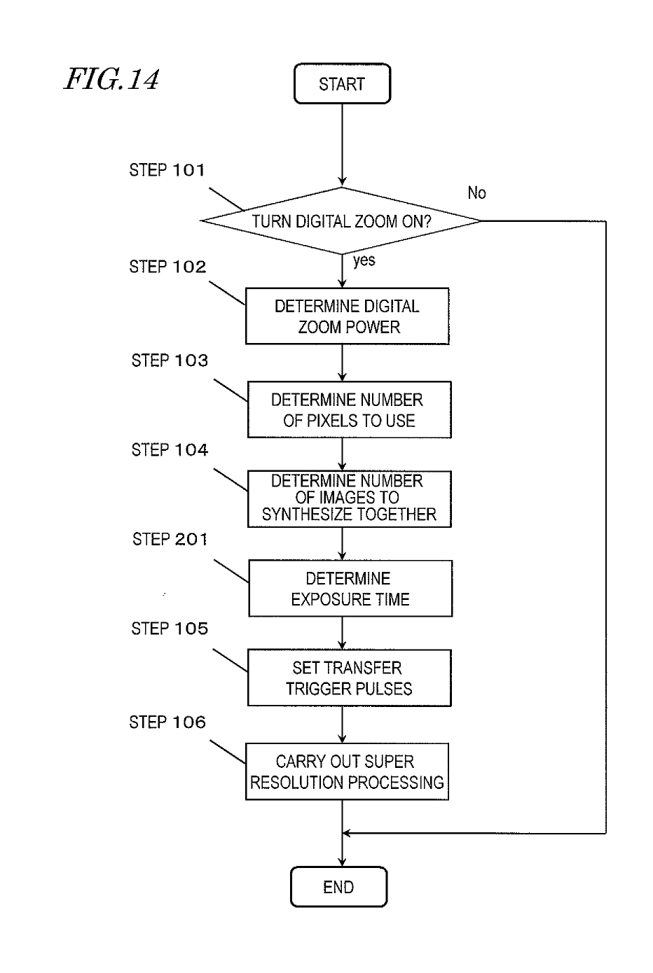

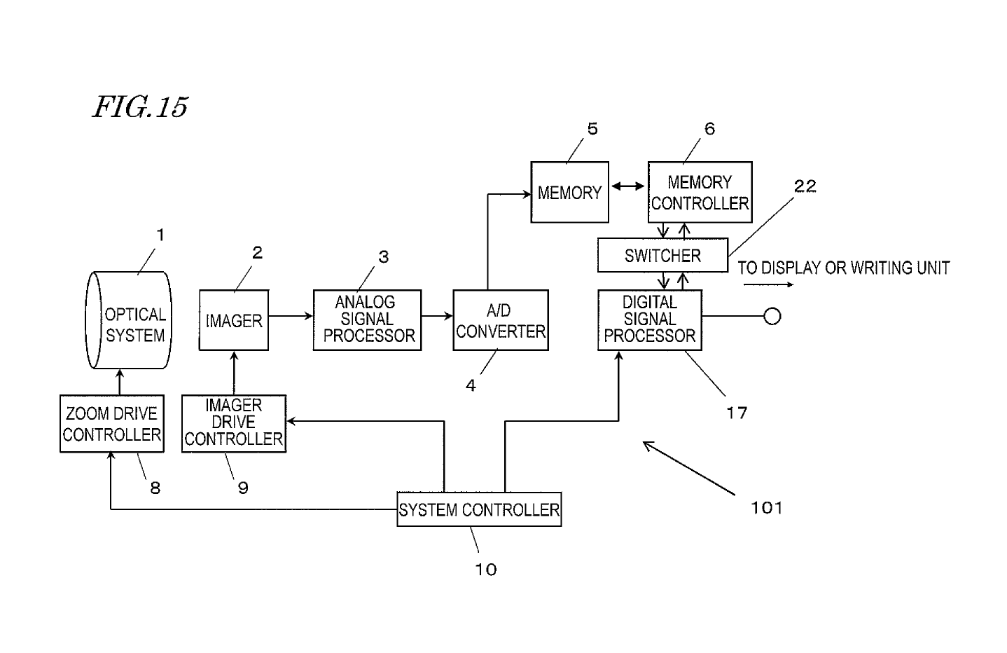

FIG. 14 is a flowchart showing an operation algorithm to be carried out in the digital zoom mode according to this preferred embodiment. The operation algorithm shown in FIG. 14 is supposed to be either performed by some hardware components built in the system controller 10 or installed as a program in the system controller 10.

Hereinafter, it will be described with reference to the accompanying drawings how the image capture device of this second preferred embodiment with such a configuration operates. The following description will be focused on only differences from the first preferred embodiment described above.

First of all, the motion estimating section 12 continuously checks out the images that have been shot by the imager 2 to see if there is any motion between those images. In this case, the motion, if any, has its magnitude and direction (i.e., its motion vector) estimated in each of the four areas defined on each image. If the magnitudes and directions of the motion vectors that have been estimated in those four areas are substantially the same, then a subject's motion flag is set to be zero. On the other hand, if the magnitudes and directions of those motion vectors are different, then the subject's motion flag is set to be one. As for the difference in the magnitude and direction between the motion vectors, predetermined threshold values may be set in advance, and the subject's motion flag may be set to be one if the magnitudes and directions of the motion vectors exceed those threshold values, for example.

Next, the image capture device of this preferred embodiment determines whether or not to turn the digital zoom mode ON, how high the digital zoom power should be if the answer is YES, how many pixels should be used in the imager, and how many images should be synthesized together in Steps 101 through 104, respectively, as in the first preferred embodiment described above.

Subsequently, in Step 201, the subject's motion flag in the motion estimating section 12 is referred to. If the flag turns out to be zero, this processing is skipped and the next processing step 105 is carried out instead. On the other hand, if the flag turns out to be one, the overall exposure time of the multiple images to be obtained from the imager 2 is determined. This processing is needed for the following reason. Specifically, if there is any moving subject in multiple images to be synthesized together, then the subject image to be generated in the synthetic image will look like a multi-exposure image, thus resulting in rather debased image quality. Thus, to avoid such an unwanted situation, the exposure time is set to be shorter, thereby reducing the influence of such a moving subject. Therefore, if the subject's motion flag turns out to be one, then it is determined that there should be a moving subject (such as a person or a vehicle) on the images shot. In that case, the overall exposure time of the multiple images shot is shortened as shown in FIG. 13. In the preferred embodiment described above, it is determined, by reference to the subject's motion flag, just whether there is any moving subject on the images or not. Optionally, the magnitude of that subject's motion may be determined to be any of multiple different levels according to the degree of distribution of the motion vectors that have been estimated by the motion estimating section 12, and the overall exposure time of the multiple images may be changed into an appropriate one of multiple levels. Specifically, in that case, the greater the magnitude of a subject's motion, the more significantly the exposure time should be shortened stepwise.

As described above, if the exposure time is changed on an image-by-image basis depending on whether or not there is any subject's motion on the image shot, a zoomed-in image of quality can still be obtained even when the subject is moving.

It should be noted that the operation of the image capture device of the first preferred embodiment described above and that of the image capture device of this preferred embodiment can be combined together. That is to say, a single image capture device can perform both the operation of the first preferred embodiment described above and that of this second preferred embodiment. For example, the image capture device may perform the processing of the first preferred embodiment shown in FIGS. 10 and 11 and then perform the processing of the second preferred embodiment shown in FIGS. 13 and 14. Alternatively, if it has turned out, as a result of the processing shown in FIGS. 13 and 14 that has been carried out earlier, that there is no subject's motion (i.e., no positional shift between multiple images) at all or that there is only a slight subject's motion falling within a predetermined range, then the modes of operation may be changed into the processing shown in FIG. 10.

### Embodiment 3

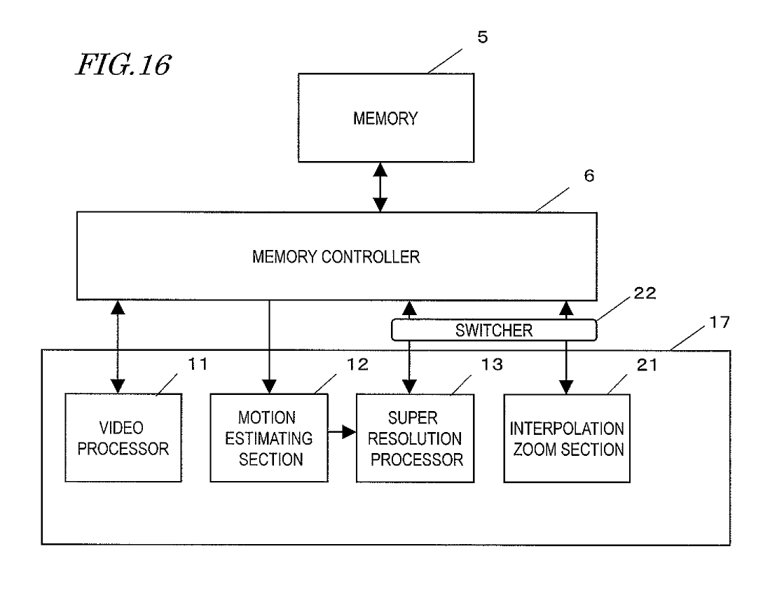

Hereinafter, an image capture device as a third specific preferred embodiment of the present invention will be described with reference to FIGS. 15, 16 and 17. In the second preferred embodiment of the present invention described above, if there is any moving subject in the images shot, the exposure times of multiple images are changed in order to prevent the super resolution processing from debasing the image quality unintentionally.

On the other hand, according to this preferred embodiment, considering that deterioration of the image quality could still be inevitable juts by changing the exposure times, if any subject's motion has been sensed in an image shot, the super resolution processing is stopped and a zoomed-in image is obtained by making interpolation on a single image as in the conventional method.

FIG. 15 illustrates a configuration for an image capture device 101 as a third preferred embodiment of the present invention.

The image capture device 101 of this preferred embodiment has a partially different configuration from the image capture device 100 of the first preferred embodiment shown in FIG. 1. In FIG. 15, any component also included in the image capture device 100 of the first preferred embodiment shown in FIG. 1 and having substantially the same function as its counterpart is identified by the same reference numeral and a detailed description thereof will be omitted herein.

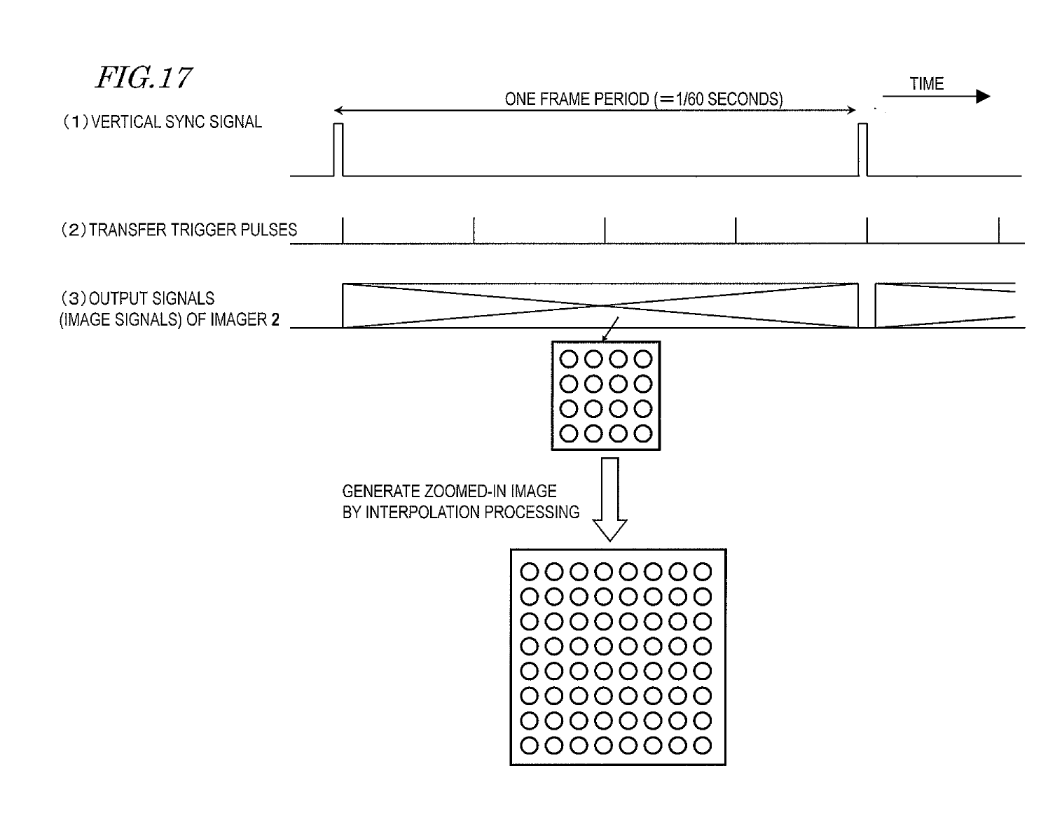

The image capture device 101 of this preferred embodiment uses a digital signal processor 17 instead of the digital signal processor 7 and further includes a switcher 22 unlike the image capture device 100 of the first preferred embodiment described above. These differences will be described in detail with reference to FIG. 16.

FIG. 16 illustrates a detailed configuration for the digital signal processor 17, the switcher 22 and their associated circuit sections of the image capture device 101 of this preferred embodiment.

The digital signal processor 17 includes the video processor 11, the motion estimating section 12, the super resolution processor 13 and an interpolation zoom section 21. That is to say, this digital signal processor 17 includes not only every component of the digital signal processor 7 of the first preferred embodiment described above but also an interpolation zoom section 21. The functions of the video processor 11, the motion estimating section 12 and the super resolution processor 13 are the same as those of their counterparts of the first preferred embodiment described above.

The interpolation zoom section 21 performs interpolation processing on given image data, thereby increasing the number of pixels of the image and zooming in on the given single image. In this case, the interpolation processing to perform in this preferred embodiment may be conventional linear interpolation or bicubic interpolation, for example.

The switcher 22 switches the input and output between the digital signal processor 17 and the memory controller 6. As will be described later, the switcher 22 selectively connects or disconnects not only the memory controller 6 and the super resolution processor 13 but also the memory controller 6 and the interpolation zoom section 21 to/from each other according to the value of the subject's motion flag. As a result, data is transmitted between one of the super resolution processor 13 and the interpolation zoom section 21 and the memory 5. It should be noted that the switcher 22 is set by default so as to provide a signal path that connects the memory controller 6 and the super resolution processing 13 together (in ON state) but disconnect the memory controller 6 from the interpolation zoom section 21 (in OFF state).

FIG. 17 illustrates a timing diagram showing how image signals are obtained from the imager 2 shown in FIG. 1. In FIG. 17, portion (1) illustrates vertical sync pulses, portion (2) illustrates transfer trigger pulses, which are given as a trigger for transferring the electric charges stored in the imager 2 to an external device, and portion (3) illustrates the output signals (image signals) of the imager 2. As shown in FIG. 17, the image capture device of this preferred embodiment fixes the intervals at which the transfer trigger pulses are applied at one frame period based on a result of a subject's motion estimation as will be described later, thereby getting one image signal per frame period.

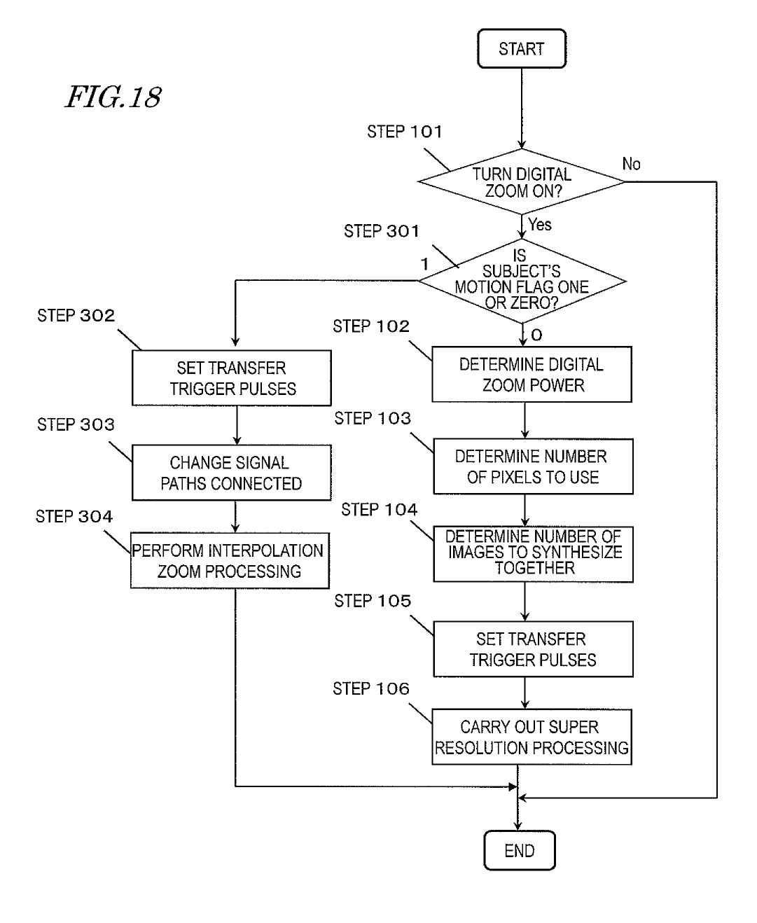

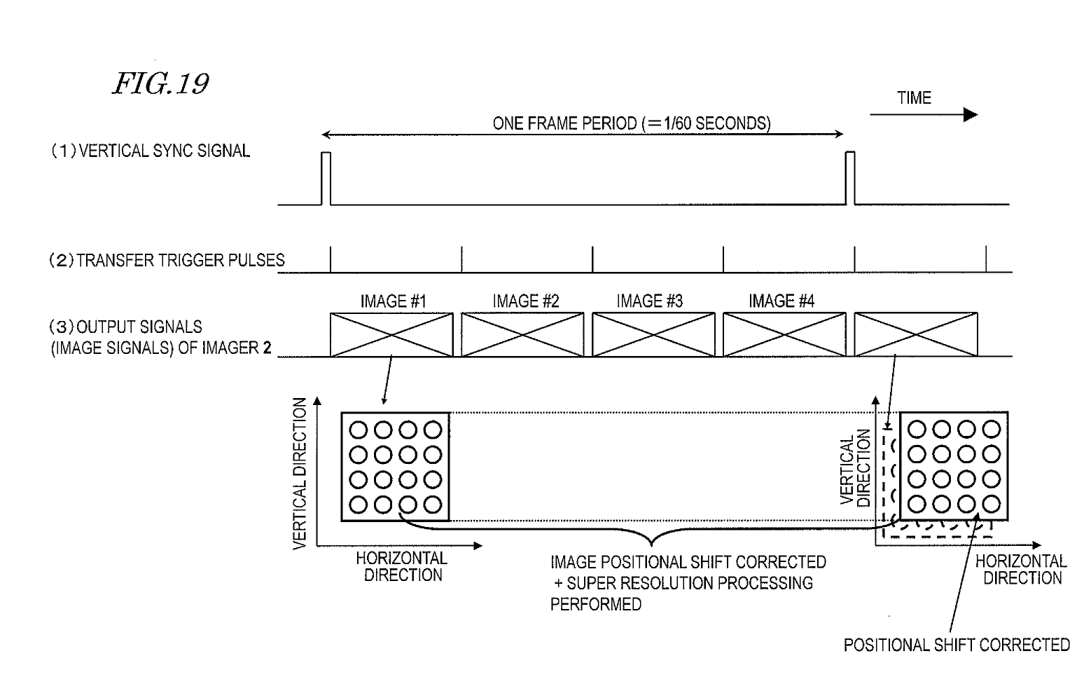

FIG. 18 is a flowchart showing an operation algorithm to be carried out in the digital zoom mode according to this preferred embodiment. The operation algorithm shown in FIG. 18 is supposed to be either performed by some hardware components built in the system controller 10 or installed as a program in the system controller 10.

Hereinafter, it will be described how the image capture device of this preferred embodiment with such a configuration operates. However, the following description of this third preferred embodiment will be focused on only the differences from the operation of the image capture device 100 of the first preferred embodiment described above.

First of all, the motion estimating section 12 continuously checks out the images that have been shot by the imager 2 to see if there is any motion between those images. In this case, the motion, if any, has its magnitude and direction (i.e., its motion vector) estimated in each of the four areas defined on each image. If the magnitudes and directions of the motion vectors that have been estimated in those four areas are substantially the same, then a subject's motion flag is set to be zero. On the other hand, if the magnitudes and directions of those motion vectors are different, then the subject's motion flag is set to be one. As for the difference in the magnitude and direction between the motion vectors, predetermined threshold values may be set in advance, and the subject's motion flag may be set to be one if the magnitudes and directions of the motion vectors exceed those threshold values, for example.

Next, in Step 301, the image capture device of this preferred embodiment refers to the subject's motion flag in the motion estimating section 12. If the flag turns out to be zero, this processing is skipped and the next processing step 102 is carried out instead. On the other hand, if the flag turns out to be one, then the process advances to Step 302. The processing steps 102 through 105 are the same as the processing steps 102 through 105 of the first preferred embodiment described above, and the description thereof will be omitted herein.

In Step 302, a transfer trigger pulse is set and the imager drive controller 9 drives the imager 2 so that one image is obtained from the imager 2 per frame period. Next, in Step 303, the switcher 22 is controlled so as to disconnect the signal path between the memory 5 and the super resolution processor 13 but connect the signal path between the memory 5 and the interpolation zoom section 21 instead. Subsequently, in Step 304, the interpolation zoom section 21 is controlled so as to perform zoom processing on the image data representing a single image that has been retrieved from the memory 5.

As described above, by changing the digital zoom modes depending on whether or not there is any subject's motion on the images shot, it is possible to avoid an unwanted situation where the super resolution processing debases the image quality unintentionally if there is any subject moving. As a result, a zoomed-in image with no collapsing parts can be obtained.

The preferred embodiments of the present invention described above are only examples of the present invention and various modifications or variations can be readily made on them without departing from the true spirit and scope of the present invention.

(A) According to the third preferred embodiment of the present invention described above, the modes of operation are supposed to be changed between the super resolution processing and the interpolation zoom processing depending on whether or not there is any subject moving on the images shot. However, the modes of operation may also be changed by detecting any change of status of the image capture device itself such as its battery charge level or a rise in the temperature of the device. Specifically, if the super resolution processing is carried out, multiple images are shot in one frame period and subjected to the super resolution processing. That is why the power dissipation of the device would be greater than usual. In view of this consideration, if the battery built in the device has a low charge level, the modes of operation may be changed from the digital zoom mode into the interpolation zoom mode in order to perform the shooting session as long as possible. In that case, the power dissipation can be cut down and the image capture device can perform shooting for a longer time because the interpolation zooming usually requires a lower degree of computational complexity than the super resolution processing does and because only one image needs to be used. On top of that, if the power dissipation increases, then the temperature of the device could rise, which might affect the stability of operation of the device. That is why it will be effective to change the modes of operation according to the temperature detected by a temperature sensor built in the device so that the super resolution processing is carried out if the temperature of the device is equal to or lower than a predetermined value and that the interpolation zoom processing is carried out if the temperature is higher than the predetermined value.

(B) As for the preferred embodiments of the present invention described above, it has not been mentioned at all how to change the modes of carrying out this invention depending on whether the video to shoot is a moving picture or a still picture. However, no matter whether the video to shoot is a moving picture or a still picture, the image capture device of any of the preferred embodiments of the present invention described above can always be used effectively. For example, if the video to shoot is a moving picture, the operations to get done in one frame period as already described with reference to FIG. 10 just need to be done sequentially. Then, even when a moving picture is being shot, digital zoom of quality is still realized. On the other hand, if the video to shoot is a still picture, the operations to get done in one frame period as already described with reference to FIG. 10 may be carried out at any time after the shutter releases button has been pressed by the user. And the image thus obtained may be stored as a still picture. It should be noted that in shooting a still picture, one frame period is an exposure time to be determined by the brightness of the subject and the aperture of the diaphragm, i.e., a shutter speed. And one frame period does not have to have a fixed value such as 1/60 seconds that was taken as an example in the foregoing description of preferred embodiments of the present invention.

(C) In the preferred embodiments of the present invention described above, when multiple images are synthesized together with pixels shifted by the super resolution processing, there is no problem if the magnitudes of shift between the pixels of each pair of images should always be within the grid points as shown in portion (6) of FIG. 7. Specifically, in the example illustrated in portion (6) of FIG. 7, the image of Frame #2 has vertically shifted from the image of Frame #1 by a half pixel. The image of Frame #3 has obliquely shifted from the image of Frame #2 by a half pixel in a 45 degree direction. And the image of Frame #4 has horizontally shifted from the image of Frame #3 by a half pixel. However, the magnitude of shift is not always that small if the shift between multiple images has been caused by a camera shake during shooting, for example.

In that case, it is not until the pixel locations have been moved by making pixel interpolation one by one with one of multiple images used as a reference so that the pixels of the other images are located on expected grid points that the super resolution processing may be started. Alternatively, either the imager 2 or the optical system 2 may be physically shifted when each image is exposed, thereby producing pixel shifts as intended.

(D) The image capture device of any of the preferred embodiments of the present invention described above may also be a camera with an interchangeable lens such as a single-lens reflex camera.

(E) Furthermore, in the preferred embodiments of the present invention described above, if multiple images need to be obtained from the imager 2 within one frame period, those images could be rather dark ones according to their exposure time. However, such dark images can naturally be eliminated by adjusting the optical diaphragm based on the number of images to get in one frame period and the exposure time or by amplifying the output signal of the imager 2.

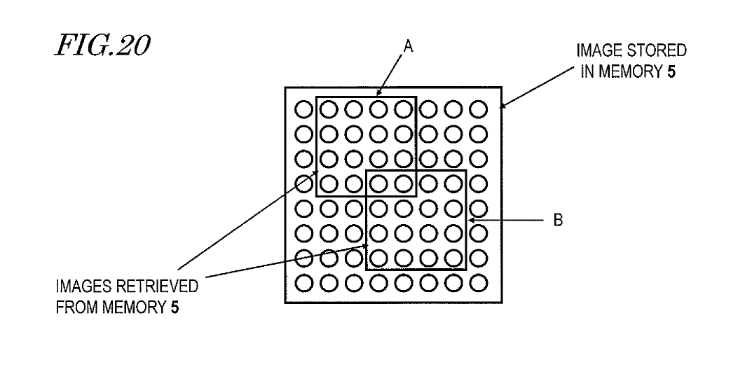

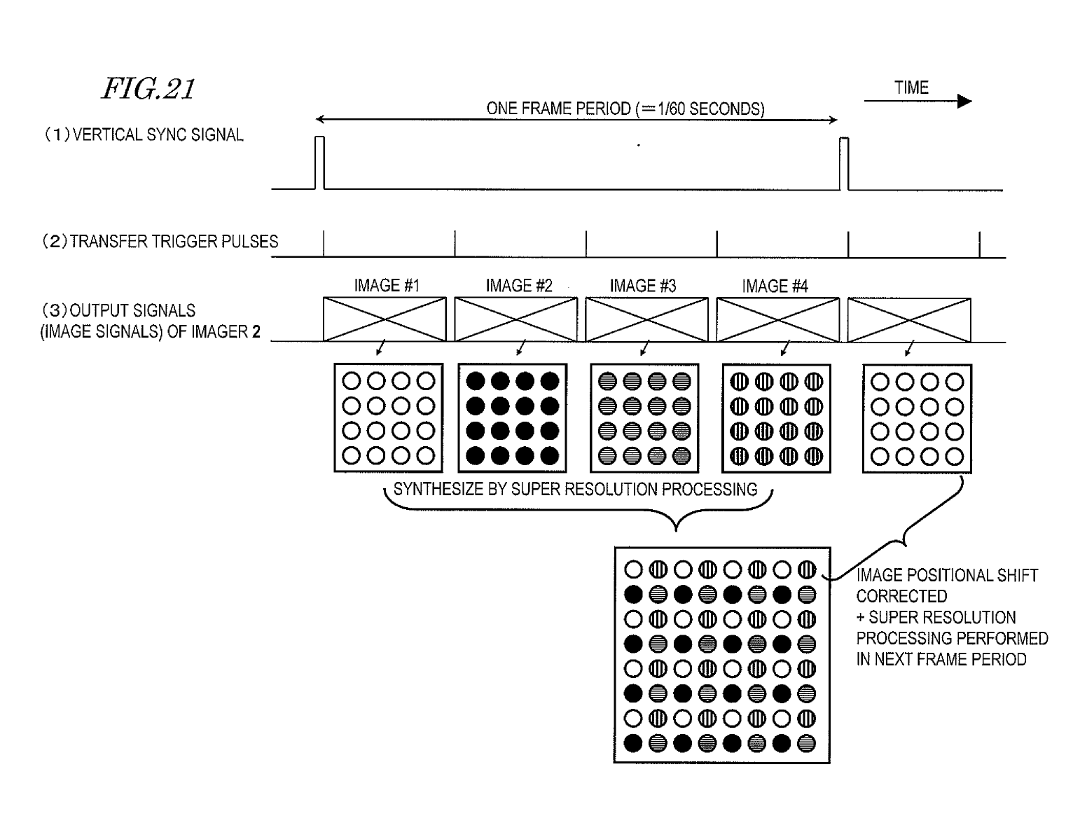

(F) Furthermore, in the preferred embodiments of the present invention described above, if a moving picture is going to be shot and if the shooter is shooting the moving picture with the image capture device held with his or her hands, then even the moving picture synthesized by the super resolution processing will still have some shakiness caused by the camera shake. Such shakiness will increase significantly particularly in the digital zoom mode and could make the audience of the moving picture feel dizzy and uncomfortable. Thus, such image shakiness can be reduced by any of the following three methods:
(F-1) One method is to choose one of the multiple images to be synthesized together in the digital zoom mode as a reference, provided that the image is generated at a particularly timing. For example, in the frame period shown in FIG. 10, the first image (i.e., Image #1) that has been generated after the vertical sync signal shown in portion (1) of FIG. 10 has risen may be used as a reference. Then, the motion estimating section 12 detects the magnitude of positional shift between the two reference images (each of which is the first image that has been generated after the vertical sync signal has risen) of two consecutive frame periods. And then the motion estimating section 12 makes correction so that the reference image of the current frame period is aligned with the reference image of the previous frame period (see FIG. 19). After that, the reference image of the current frame period, which has been aligned with the reference image of the previous frame period, and the other images that have been shot within the same frame period (i.e., Images #2 through #4) are synthesized together by the super resolution processing. Then, in the digitally zoomed-in image, any subject is located at the same position in one frame period to another, and therefore, the image shakiness caused by the camera shake has been reduced significantly. The reference image of the current frame period may be aligned with the reference image of the previous frame period by the following method, for example. First of all, the number of pixels of the image signal to be obtained from the imager 2 may be set to be greater than the number of the pixels to use that is determined in the processing step 103 shown in FIG. 11, thereby securing an alignment margin. And the image is stored in the memory 5. Next, based on the magnitude of shift between the two images that has been detected by the motion estimating section 12, the image signal is retrieved from the memory 5 with its retrieval position shifted to A or B as shown in FIG. 20. As for a shift of one pixel or less, a pixel signal representing an intermediate position between two pixels may be generated by interpolation and used to align those images with each other. In this example, the reference image of each frame period is supposed to be the first image that has been generated after the vertical sync signal has risen. However, this is just an example of the present invention. And there is no problem at all even if the reference image is an intermediate image or the last image.
(F-2) Another method is also to choose one of the multiple images to be synthesized together in the digital zoom mode as a reference, provided that the image is generated at a particularly timing. For example, in the frame period shown in FIG. 21, the first image (i.e., Image #1) that has been generated after the vertical sync signal shown in portion (1) has risen may be used as a reference. Then, the motion estimating section 12 detects the magnitude of positional shift between the synthetic image that has been generated in the previous frame period through the super resolution processing and this reference image. And then the motion estimating section 12 makes correction so that the reference image of the current frame period is aligned with the synthetic image of the previous frame period. After that, the reference image of the current frame period, which has been aligned with the synthetic image generated in the previous frame period through the super resolution processing, and the other images that have been shot within the same frame period as the reference image (i.e., Images #2 through #4) are synthesized together by the super resolution processing. Then, in the digitally zoomed-in image, any subject is located at the same position in one frame period to another, and therefore, the image shakiness caused by the camera shake has been reduced significantly. It should be noted that since the two synthetic images that have been generated in the previous and current frame periods through the super resolution processing have mutually different number of pixels, sometimes it could be difficult to estimate the motion directly. In that case, however, the motion can naturally be estimated either after the synthetic image has been sub-sampled or after the reference image is sub-sampled to adjust the number of pixels to that of the synthetic image.
(F-3) A method is to store a digitally zoomed-in image, which has been obtained by synthesizing together multiple images through the super resolution processing, is once stored in the memory 5. Then, such digitally zoomed-in images are retrieved one after another. The magnitude of shift between those zoomed-in images of consecutive frame periods is detected by the motion estimating section 12. And based on the magnitude of the shift detected, the image signal is retrieved from a shifted position in the memory 5 as already been described with respect to the method of the first preferred embodiment. Then, in the digitally zoomed-in image thus synthesized, any subject is located at the same position in one frame period to another, and therefore, the image shakiness caused by the camera shake has been reduced significantly.

The present invention can be used effectively in an image capture device with an image zooming function such as a digital camera or a camcorder (video movie camera).

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. An image capture device comprising:
an optical system configured to produce a subject image;
an imager configured to receive the subject image, to generate an image signal and to output the image signal in accordance with a read instruction;
a drive controller configured to control an interval at which the read instruction is output to the imager;
a memory configured to store image data that has been obtained based on the image signal;
a motion estimating section configured to estimate at least one motion vector with respect to the subject based on the image data of multiple images; and
a super resolution processor configured to perform super resolution processing for generating image data representing a new image by synthesizing together the multiple images by reference to the at least one motion vector,
wherein if the super resolution processor is not turned ON, the drive controller outputs the read instruction to the imager at a first interval, and
wherein if the super resolution processor is turned ON, the drive controller outputs the read instructions to the imager a number of times at a second interval, which is shorter than the first interval, and the memory stores image data representing multiple images that have been obtained in accordance with the read instructions.

2. The image capture device of claim 1, wherein the new image generated by the super resolution processor has a greater number of pixels than any of the multiple images.

3. The image capture device of claim 1, wherein the super resolution processor synthesizes the multiple images together by making correction on a positional shift between the multiple images using the at least one motion vector.

4. The image capture device of claim 3, wherein the multiple images include one basic image and at least one reference image, and
wherein the motion estimating section estimates the at least one motion vector based on the position of a pattern representing the subject on the basic image and the position of a pattern representing the subject on the at least one reference image, and
wherein the super resolution processor makes correction on the positional shift between the multiple images based on the magnitude and direction of motion represented by the at least one motion vector so that the respective positions of the pattern representing the subject on the basic image and on the at least one reference image agree with each other.

5. The image capture device of claim 3, wherein the super resolution processing performs super resolution processing for generating image data representing a new image by synthesizing together the multiple images with some pixels of the images shifted from each other.

6. The image capture device of claim 1, further comprising a controller configured to determine whether or not to turn ON the super resolution processor and configured to control changing the modes of operation from a normal shooting mode into a digital zoom mode, and vice versa,
wherein in the normal shooting mode, an image with a first number of pixels is generated, and
wherein in the digital zoom mode, digital zoom processing is carried out using an image with a second number of pixels, which form part of the first number of pixels, and
wherein the controller does not turn the super resolution processor ON in the normal shooting mode, and
wherein when changing the modes of operation from the normal shooting mode into the digital zoom mode, the controller turns the super resolution processor ON.

7. The image capture device of claim 5, wherein the optical system includes at least one lens for carrying out optical zoom processing, and
wherein in the normal shooting mode, the optical zoom processing is carried out using the at least one lens, and when the zoom power of the optical zoom processing substantially reaches its upper limit, the controller changes the modes of operation from the normal shooting mode into the digital zoom mode.

8. The image capture device of claim 6, wherein in the digital zoom mode, as the zoom power increases, the drive controller shortens the second interval stepwise and output the read instructions to the imager a number of times.

9. The image capture device of claim 1, wherein the drive controller determines, by the at least one motion vector, whether or not the magnitude of motion of the subject is greater than a predetermined value, and shortens the second interval stepwise if the magnitude of motion is greater than the predetermined value.

10. The image capture device of claim 1, wherein the drive controller determines, by the at least one motion vector, whether or not the magnitude of motion of the subject is greater than a predetermined value, and
wherein if the magnitude of motion is greater than the predetermined value, the controller does not turn the super resolution processor ON, and
wherein if the magnitude of motion is equal to or smaller than the predetermined value, the controller turns the super resolution processor ON.

11. The image capture device of claim 1, further comprising
an interpolation zoom section configured to increase the number of pixels based on the image data of a single image, and
a switcher configured to selectively turn ON one of the super resolution processor and the interpolation zoom section according to a status of the image capture device itself.

12. The image capture device of claim 11, wherein the switcher selectively turns ON one of the super resolution processor and the interpolation zoom section according to a battery charge level of the image capture device itself.

13. The image capture device of claim 11, wherein the switcher selectively turns ON one of the super resolution processor and the interpolation zoom section according to the temperature of the image capture device itself.
